(19) United States
(12) Patent Application Publication
(10) Pub. No.: US 2022/0030865 A1
(43) Pub. Date: Feb. 3, 2022

(54) COMPOSITIONS COMPRISING FLORPYRAUXIFEN THAT SAFEN WHITE CLOVER AND METHODS OF USE THEREOF

(71) Applicant: CORTEVA AGRISCIENCE LLC, Indianapolis, IN (US)

(72) Inventors: Vernon Langston, Montgomery, TX (US); Richard K. Mann, Mead, CO (US); Jeff A. Nelson, Indianapolis, IN (US); Patrick L. Burch, Christianburg, VA (US); Ernest S. Flynn, Indianapolis, IN (US); Byron B. Sleugh, Indianapolis, IN (US); Andrew Bailey, Clophill (GB)

(73) Assignee: CORTEVA AGRISCIENCE LLC, Indianapolis, IN (US)

(21) Appl. No.: 17/311,706

(22) PCT Filed: Dec. 13, 2019
(86) PCT No.: PCT/US19/66288

§ 371 Date: Jun. 8, 2021

Related U.S. Application Data
(60) Provisional application No. 62/783,403, filed on Dec. 21, 2018.

(51) Int. Cl. A01N 43/40; A01N 43/54

(52) U.S. Cl. CPC A01N 43/40; A01N 43/54

(57) ABSTRACT

Disclosed herein are compositions comprising florpyrauxifen, an agriculturally acceptable salt or ester thereof, or combinations thereof, and a second herbicide, wherein the compositions are safened for use on white clover. The second herbicide may be selected from 2,4-D, amidosulfuron, saflufenacil, an agriculturally acceptable salt or ester thereof, or combinations thereof.

### CROSS REFERENCE TO RELATED APPLICATION

This application claims the benefit of priority of U.S. Provisional Application No. 62/783,403, filed Dec. 21, 2018, which is incorporated by reference herein in its entirety.

### FIELD

The present disclosure includes compositions comprising florpyrauxifen or an agriculturally acceptable salt, ester, or combination thereof, and 2,4-D or agriculturally acceptable salts, esters, or combinations thereof, wherein the compositions are safened for use on white clover. The present disclosure also includes compositions containing florpyrauxifen, an agriculturally acceptable salt or ester thereof, or combinations thereof and amidosulfuron or agriculturally acceptable salts, esters, or combinations thereof, wherein the compositions are safened for use on white clover. The present disclosure also includes compositions containing florpyrauxifen, an agriculturally acceptable salt or ester thereof, or combinations thereof and saflufenacil or agriculturally acceptable salts, esters, or combinations thereof, wherein the compositions are safened for use on white clover. The present disclosure also includes methods of controlling undesirable vegetation, while reducing herbicidal damage to white clover, using these compositions.

### BACKGROUND

White clover (Trifolium repens, TRFRE) is a ground cover plant with stems that form stolons (runners) that take root to germinate new plants. In some land-use applications, such as lawns and golf courses, white clover may be considered a weed, but in other applications, such as fallow lands, pasture, and range lands, white clover may be highly desirable. White clover can be a beneficial plant, because it may help, for example, fix nitrogen in the soil, prevent soil erosion, and act as “green mulch” to retain moisture in the soil. It is also an important forage legume, with leaves and flowers that are high in protein, and it tolerates close grazing because of its stolon formation.

A need therefore exists to find herbicidal compositions that can protect white clover while controlling other undesirable plant species in certain land-use applications, such as range, pasture, and fallow lands.

### SUMMARY

Provided herein are compositions comprising florpyrauxifen, an agriculturally acceptable salt or ester thereof, or combinations thereof, and a second herbicide, wherein the compositions are safened for use on white clover. The second herbicide may be selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof. The compositions may also comprise a third herbicide, selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof. The compositions may also comprise a fourth herbicide, selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof. The compositions may also contain one or more agriculturally acceptable adjuvants or carriers and additional inert ingredients.

Provided herein also are methods of using compositions containing florpyrauxifen, an agriculturally acceptable salt or ester thereof, or combinations thereof and a second herbicide, wherein the compositions are safened for use on white clover. The second herbicide may be selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof. The methods may also use compositions comprising a third herbicide or a fourth herbicide, each selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof.

### DETAILED DESCRIPTION

The present disclosure includes compositions comprising florpyrauxifen, an agriculturally acceptable salt or ester thereof, or combinations thereof, and 2,4-D, an agriculturally acceptable salt or ester thereof, or combinations thereof, wherein the compositions are safened for use on white clover. The present disclosure also includes compositions comprising florpyrauxifen, an agriculturally acceptable salt or ester thereof, or combinations thereof and amidosulfuron, an agriculturally acceptable salt or ester thereof, or combinations thereof, wherein the compositions are safened for use on white clover. The present disclosure also includes compositions containing florpyrauxifen, an agriculturally acceptable salt or ester thereof, or combinations thereof and saflufenacil or agriculturally acceptable salts, esters, or combinations thereof, wherein the compositions are safened for use on white clover. The present disclosure also includes methods of controlling undesirable vegetation, while reducing herbicidal damage to white clover, using these compositions. In some aspects, the compositions are used to control undesirable vegetation, while reducing herbicidal damage to white clover. This may be beneficial in certain land-use applications, such as range, pasture, fallow lands, natural areas, wildlife habitats, and other non-crop land areas.

I. Definitions

Terms used herein will have their customary meaning in the art unless specified otherwise. The singular forms “a” and “the” include plural references unless stated otherwise. To the extent that the term “or” is employed (e.g., A or B) it is intended to mean “A or B or both.” If this disclosure intends to indicate “only A or B but not both” then the term “only A or B but not both” will be employed. Thus, use of the term “or” herein is the inclusive and not the exclusive use.

The compositions and methods disclosed herein include compositions comprising florpyrauxifen, an agriculturally acceptable salt or ester thereof, or combinations thereof, and a second herbicide. The second herbicide is selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof. The compositions and methods disclosed herein may also include compositions comprising a third herbicide, selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof. The compositions may also comprise a fourth herbicide, selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof.

As used herein, references to “florpyrauxifen,” “2,4-D,” “amidosulfuron,” “saflufenacil,” the “second herbicide,” the “third herbicide,” or the “fourth herbicide” may be understood to include agriculturally acceptable salts or esters thereof, or combinations thereof, unless specified otherwise.

Also, as used herein, references to “florpyrauxifen and the second herbicide” may be understood to optionally include the third herbicide or the fourth herbicide, unless explicitly specified otherwise.

As used herein, the terms “herbicide” and “herbicidal active ingredient” may be understood to include an active ingredient that kills, controls, or otherwise adversely modifies the growth of vegetation, particularly undesirable vegetation such as weed species, when applied in an appropriate amount.

As used herein, the term “herbicidal effect” may be understood to include an adversely modifying effect of an active ingredient on vegetation, including, for example, a deviation from natural growth or development, killing, regulation, desiccation, growth inhibition, growth reduction, and retardation. The term “herbicidal activity” refers generally to herbicidal effects of an active ingredient.

As used herein, “applying” a herbicide or herbicidal composition refers to delivering it directly to the targeted vegetation or to the locus thereof or to the area where control of undesirable vegetation is desired. Methods of application include, but are not limited to, pre-emergently contacting soil or water, post-emergently contacting the undesirable vegetation, or contacting the area adjacent to the undesirable vegetation.

As used herein, the term “safen” and “safening effect” may be understood to mean that a herbicide or herbicidal composition has a reduced herbicidal effect on a desirable plant when compared to the expected herbicidal effect of the herbicidal compound or herbicidal composition on that plant. “Safen” or “safening effect” may also be understood to mean that a herbicide or herbicidal composition improves selectivity between the desirable vegetation and the undesirable vegetation being targeted by the herbicide or herbicidal composition. A safening effect may be identified when the measured herbicidal effect of the herbicidal composition on the desirable vegetation is less than the expected herbicidal effect calculated by the Colby equation.

As used herein, the term “vegetation” can include, for instance, dormant seeds, germinating seeds, emerging seedlings, plants propagating from vegetative propagules, immature vegetation, and established vegetation.

As used herein, the term “undesirable vegetation” refers to vegetation that is not wanted in a given area, for instance, weed species. Herbicides or herbicidal compositions are used to control undesirable vegetation. Preferably, herbicides or herbicidal compositions have a large or significant herbicidal effect on undesirable vegetation.

As used herein, the term “desirable vegetation” refers to vegetation that is wanted in a given area, for instance, crops, lawns, ornamental plants, ground cover, foraging plants, forbs, shrubbery, and trees. Preferably, herbicides or herbicidal compositions have a small or no herbicidal effect on desirable vegetation.

As used herein, “active ingredient” or “ai” may be understood to include a chemical compound or composition that has an effect on vegetation, for example, a herbicidal effect or a safening effect on the vegetation.

As used herein, “acid equivalent” or “ae” may be understood to include the amount of the acid form of an active ingredient that is calculated from the amount of a salt or ester form of that active ingredient. For example, if the acid form of an active ingredient “Z” has a molecular weight of 100 Dalton, and the salt form of Z has a molecular weight of 130 Dalton, an application of 130 g ai/ha of the Z salt would be equal to applying 100 g ae/ha of the acid form of Z:

130 g ai/ha Z salt*(100 Da Z acid/130 Da Z salt)=100 g ae/ha Z acid.

As used herein, agriculturally acceptable salts and esters may be understood to include salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

II. Florpyrauxifen

Florpyrauxifen, or 4-amino-3-chloro-6-(4-chloro-2-fluoro-3-methoxyphenyl)-5-fluoro-pyridine-2-carboxylic acid, has the following structure:

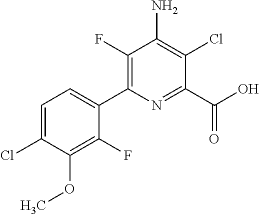 [SMILES: COc1c(Cl)ccc(-c2nc(C(=O)O)c(Cl)c(N)c2F)c1F]

Florpyrauxifen and methods of preparing florpyrauxifen have been described in U.S. Pat. No. 7,314,849, which is hereby expressly incorporated by reference in its entirety. Exemplary uses of florpyrauxifen include controlling undesirable vegetation, including grass, broadleaf, and sedge weeds in many non-crop and crop applications.

In some aspects, florpyrauxifen can be provided as an agriculturally acceptable ester. Exemplary agriculturally acceptable esters of florpyrauxifen include, but are not limited to, methyl ester, ethyl ester, propyl esters (e.g., isopropyl ester), butyl esters (e.g., tert-butyl ester), pentyl esters (e.g., cyclopentyl ester), hexyl esters (e.g., n-hexyl ester), heptyl esters (e.g., 1-methylhexyl ester), octyl esters (e.g., meptyl ester), and benzyl ester. In some aspects, florpyrauxifen can be provided as florpyrauxifen benzyl, shown below:

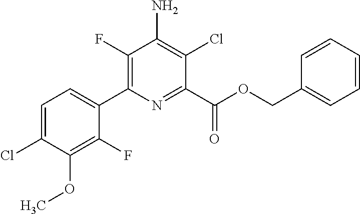 [SMILES: COc1c(Cl)ccc(-c2nc(C(=O)OCc3ccccc3)c(Cl)c(N)c2F)c1F]

In some aspects, florpyrauxifen can be provided as an agriculturally acceptable salt. Exemplary agriculturally acceptable salts of florpyrauxifen include, but are not limited to: sodium salts; potassium salts; ammonium salts or substituted ammonium salts, in particular mono-, di- and tri-C₁-C₈-alkylammonium salts such as methyl ammonium, dimethylammonium and isopropylammonium; mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts; olamine salts; diglycolamine salts; choline salts; and quaternary ammonium salts such as those represented by the formula R⁹R¹⁰R¹¹R¹²N⁺ and wherein R⁹, R¹⁰, R¹¹ and R¹² (e.g., R⁹-R¹²) each independently can represent hydrogen, C₁-C₁₀ alkyl, C₂-C₈ alkenyl, C₂-C₈ alkynyl, C₁-C₈ alkoxy, C₁-C₈ alkylthio, or aryl groups, provided that R⁹-R¹² are sterically compatible.

Florpyrauxifen, or an agriculturally acceptable salt or ester thereof, can be applied to vegetation or an area adjacent the vegetation or applied to soil or water to prevent the emergence or growth of vegetation in an amount sufficient to induce a herbicidal effect. In some aspects, florpyrauxifen, or an agriculturally acceptable salt or ester thereof, may be applied to vegetation or an area adjacent the vegetation or applied to soil or water to prevent the emergence or growth of vegetation in an amount of 1 grams acid equivalent per hectare (g ae/ha) or greater, such as 1.1 g ae/ha or greater, 1.2 g ae/ha or greater, 1.3 g ae/ha or greater, 1.4 g ae/ha or greater, 1.5 g ae/ha or greater, 1.6 g ae/ha or greater, 1.7 g ae/ha or greater, 1.8 g ae/ha or greater, 1.9 g ae/ha or greater, 2 g ae/ha or greater, 2.25 g ae/ha or greater, 2.5 g ae/ha or greater, 2.75 g ae/ha or greater, 3 g ae/ha or greater, 4 g ae/ha or greater, 5 g ae/ha or greater, 6 g ae/ha or greater, 7 g ae/ha or greater, 8 g ae/ha or greater, 9 g ae/ha or greater, 10 g ae/ha or greater, 11 g ae/ha or greater, 12 g ae/ha or greater, 13 g ae/ha or greater, 14 g ae/ha or greater, 15 g ae/ha or greater, 16 g ae/ha or greater, 17 g ae/ha or greater, 18 g ae/ha or greater, 19 g ae/ha or greater, 20 g ae/ha or greater, 22 g ae/ha or greater, 24 g ae/ha or greater, 25 g ae/ha or greater, 26 g ae/ha or greater, 28 g ae/ha or greater, or 29 g ae/ha or greater; in an amount of 30 g ae/ha or less, such as 29 g ae/ha or less, 28 g ae/ha or less, 26 g ae/ha or less, 25 g ae/ha or less, 24 g ae/ha or less, 22 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, 11 g ae/ha or less, 10 g ae/ha or less, 9 g ae/ha or less, 8 g ae/ha or less, 7 g ae/ha or less, 6 g ae/ha or less, 5 g ae/ha or less, 4 g ae/ha or less, 3 g ae/ha or less, 2.75 g ae/ha or less, 2.5 g ae/ha or less, 2.25 g ae/ha or less, 2 g ae/ha or less, 1.9 g ae/ha or less, 1.8 g ae/ha or less, 1.7 g ae/ha or less, 1.6 g ae/ha or less, 1.5 g ae/ha or less, 1.4 g ae/ha or less, 1.3 g ae/ha or less, 1.2 g ae/ha or less, or 1.1 g ae/ha or less; or in an amount within any range defined between any pair of the preceding values, such as 1-30 g ae/ha, 1.3-24 g ae/ha, 2.25-20 g ae/ha, 4 g ae/ha-17 g ae/ha, 9 g ae/ha to 19 g ae/ha, or 12-28 g ae/ha.

III. Second Herbicide

In addition to florpyrauxifen or an agriculturally acceptable salt or ester thereof, the compositions can include a second herbicide, wherein the compositions are safened for use on white clover. The second herbicide may be selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof.

A. 2,4-D

In addition to florpyrauxifen or an agriculturally acceptable salt or ester thereof, the compositions can include the second herbicide 2,4-D or an agriculturally acceptable salt or ester thereof or combinations thereof. 2,4-D, shown below, is a synthetic auxin herbicide that mimics natural plant hormones and can inhibit cell division and growth. 2,4-D provides broad spectrum control of many annual, biannual and perennial broad-leaved weeds and aquatic broad-leaved weeds in cereals, maize, sorghum, grasslands, established turf, grass seed crops, orchards (pome fruit and stone fruit), cranberries, asparagus, sugar cane, rice, forestry, and on non-crop land (including areas adjacent to water). 2,4-D, as well as methods of preparing 2,4-D, are known in the art. Its herbicidal activity is described, for example, in The Pesticide Manual, Seventeenth Edition, 2016.

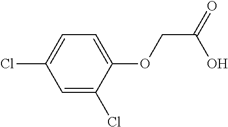 [SMILES: O=C(O)COc1ccc(Cl)cc1Cl]

In some aspects, 2,4-D can be provided as an agriculturally acceptable salt or ester of 2,4-D. Exemplary agriculturally acceptable salts and esters of 2,4-D include, but are not limited to, 2,4-D-ammonium, 2,4-D-butotyl, 2,4-D-2-butoxypropyl, 2,4-D-3-butoxypropyl, 2,4-D-butyl, 2,4-D choline, 2,4-D-diethylammonium, 2,4-D-dimethylammonium (2,4-D DMA), 2,4-D-diolamine, 2,4-D-dodecylammonium, 2,4-D-ethyl, 2,4-D-2-ethylhexyl (2,4-D EHE), 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, and clacyfos. In some aspects, the 2,4-D can be provided as 2,4-D-2-ethylhexyl (2,4-D EHE), shown below.

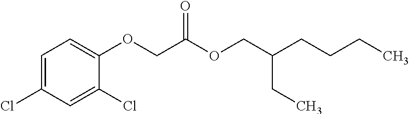 [SMILES: CCCCC(CC)COC(=O)COc1ccc(Cl)cc1Cl]

In some aspects, 2,4-D can be provided as 2,4-D DMA, shown below.

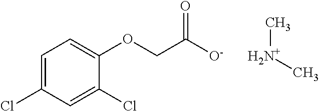

In some aspects, the 2,4-D can be provided as 2,4-D choline, shown below.

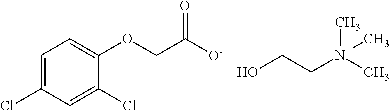

Exemplary uses of 2,4-D-choline include, but are not limited to, controlling annual and perennial broadleaf weeds, including, but not limited to, glyphosate-resistant broadleaf weeds. 2,4-D-Choline can be used in crops that have been made tolerant to 2,4-D, including, but not limited to, 2,4-D-tolerant soybeans, maize, and cotton. 2,4-D-Choline is generally, but is not required to be, applied post-emergent. 2,4-D-Choline can also be used for weed control in non-crop and perennial cropping systems.

2,4-D can be applied to vegetation or an area adjacent the vegetation or applied to soil or water to prevent the emergence or growth of vegetation in an amount sufficient to induce a herbicidal effect. In some aspects, 2,4-D may be applied to vegetation or an area adjacent the vegetation or applied to soil or water to prevent the emergence or growth of vegetation in an amount of 250 gram acid equivalent per hectare (g ae/ha) or more, such as 275 g ae/ha or more, 300 g ae/ha or more, 325 g ae/ha or more, 350 g ae/ha or more, 375 g ae/ha or more, 400 g ae/ha or more, 450 g ae/ha or more, 500 g ae/ha or more, 550 g ae/ha or more, 600 g ae/ha or more, 650 g ae/ha or more, 700 g ae/ha or more, 750 g ae/ha or more, 800 g ae/ha or more, 840 g ae/ha or more, 850 g ae/ha or more, 900 g ae/ha or more, 950 g ae/ha or more, 1000 g ae/ha or more, 1100 g ae/ha or more, 1200 g ae/ha or more, 1300 g ae/ha or more, or 1400 g ae/ha or more; in an amount of 1500 g ae/ha or less, such as 1400 g ae/ha or less, 1300 g ae/ha or less, 1200 g ae/ha or less, 1100 g ae/ha or less, 1000 g ae/ha or less, 950 g ae/ha or less, 900 g ae/ha or less, 850 g ae/ha or less, 840 g ae/ha or less, 800 g ae/ha or less, 750 g ae/ha or less, 700 g ae/ha or less, 650 g ae/ha or less, 600 g ae/ha or less, 550 g ae/ha or less, 500 g ae/ha or less, 450 g ae/ha or less, 400 g ae/ha or less, 375 g ae/ha or less, 350 g ae/ha or less, 325 g ae/ha or less, 300 g ae/ha or less, or 275 g ae/ha or less; or in an amount ranging from any of the minimum values described above to any of the maximum values described above, e.g., 250-1500 g ae/ha, 325-1300 g ae/ha, 400-900 g ae/ha, 650-1200 g ae/ha, 275-850 g ae/ha, 500-1000 g ae/ha, 600-750 g ae/ha, 750-840 g ae/ha, 1100-1400 g ae/ha, 250-400 g ae/ha, 700-1400 g ae/ha, or 300-1300 g ae/ha.

B. Amidosulfuron

In addition to florpyrauxifen or an agriculturally acceptable salt or ester thereof, the compositions can include the second herbicide amidosulfuron or an agriculturally acceptable salt or ester thereof or combinations thereof. Amidosulfuron, shown below, is an acetolactate synthase (ALS) inhibitor, which disrupts the production of amino acids in the plant and eventually leads to inhibition of DNA synthesis. Amidosulfuron provides post-emergence control of a wide range of broadleaf weeds, e.g., cleavers, in winter wheat, durum wheat, barley, rye, triticale and oats. Amidosulfuron, as well as methods of preparing amidosulfuron, are known in the art. Its herbicidal activity is described in The Pesticide Manual, Seventeenth Edition, 2016.

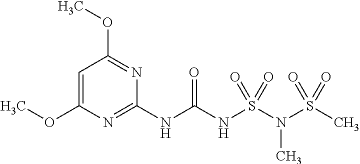

Amidosulfuron can be applied to vegetation or an area adjacent the vegetation or applied to soil or water to prevent the emergence or growth of vegetation in an amount sufficient to induce a herbicidal effect. In some aspects, amidosulfuron is applied to vegetation or an area adjacent the vegetation or applied to soil or water to prevent the emergence or growth of vegetation in an amount of 10 g ae/ha or more, such as 11 g ae/ha or more, 12 g ae/ha or more, 13 g ae/ha or more, 14 g ae/ha or more, 15 g ae/ha or more, 16 g ae/ha or more, 17 g ae/ha or more, 18 g ae/ha or more, 19 g ae/ha or more, 20 g ae/ha or more, 22 g ae/ha or more, 24 g ae/ha or more, 26 g ae/ha or more, 28 g ae/ha or more, 30 g ae/ha or more, 32 g ae/ha or more, 34 g ae/ha or more, 36 g ae/ha or more, 38 g ae/ha or more, 40 g ae/ha or more, 42 g ae/ha or more, 44 g ae/ha or more, 45 g ae/ha or more, 46 g ae/ha or more, 48 g ae/ha or more, 50 g ae/ha or more, 51 g ae/ha or more, 52 g ae/ha or more, 53 g ae/ha or more, 54 g ae/ha or more, 55 g ae/ha or more, 56 g ae/ha or more, 57 g ae/ha or more, 58 g ae/ha or more, or 59 g ae/ha or more; in an amount of 60 g ae/ha or less, such as 59 g ae/ha or less, 58 g ae/ha or less, 57 g ae/ha or less, 56 g ae/ha or less, 55 g ae/ha or less, 54 g ae/ha or less, 53 g ae/ha or less, 52 g ae/ha or less, 51 g ae/ha or less, 50 g ae/ha or less, 48 g ae/ha or less, 46 g ae/ha or less, 45 g ae/ha or less, 44 g ae/ha or less, 42 g ae/ha or less, 40 g ae/ha or less, 38 g ae/ha or less, 36 g ae/ha or less, 34 g ae/ha or less, 32 g ae/ha or less, 30 g ae/ha or less, 28 g ae/ha or less, 26 g ae/ha or less, 24 g ae/ha or less, 22 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, or 11 g ae/ha or less; or in an amount ranging from any of the minimum values described above to any of the maximum values described above, such as 10-60 g ae/ha, 14-58 g ae/ha, 17-51 g ae/ha, 5-57 g ae/ha, 22-30 g ae/ha, 26-45 g ae/ha, 48-59 g ae/ha, 19-32 g ae/ha, 11-53 g ae/ha, 32-50 g ae/ha, or 13-40 g ae/ha.

C. Saflufenacil

In addition to florpyrauxifen or an agriculturally acceptable salt or ester thereof, the compositions can include the second herbicide saflufenacil or an agriculturally acceptable salt or ester thereof or combinations thereof. Saflufenacil, shown below, is an inhibitor of a protoporphyrinogen oxidase (PROTOX), which is an enzyme involved in the biosynthesis of both heme and chlorophyll. It is believed that PROTOX inhibitors generate large amounts of singlet oxygen, which leads to the peroxidation of the lipids in cell membranes. Saflufenacil, as well as methods of preparing saflufenacil, are known in the art, and its herbicidal activity is exemplified in The Pesticide Manual. Exemplary uses of saflufenacil include: pre-emergence control of broadleaf weeds in maize and sorghum; pre-plant foliar burn-down in soybeans, cereals, cotton, and legumes; and post-directed foliar burn-down in tree fruit and nuts.

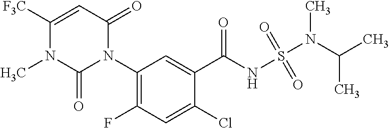 [SMILES: CC(C)N(C)S(=O)(=O)NC(=O)c1cc(-n2c(=O)cc(C(F)(F)F)n(C)c2=O)c(F)cc1Cl]

Saflufenacil can be applied to vegetation or an area adjacent the vegetation or applied to soil or water to prevent the emergence or growth of vegetation in an amount sufficient to induce a herbicidal effect. In some aspects, saflufenacil is applied to vegetation or an area adjacent the vegetation or applied to soil or water to prevent the emergence or growth of vegetation in an amount of 0.5 g ai/ha or more, such as 0.6 g ai/ha or more, 0.8 g ai/ha or more, 1 g ai/ha or more, 2 g ai/ha or more, 3 g ai/ha or more, 4 g ai/ha or more, 5 g ai/ha or more, 6 g ai/ha or more, 7 g ai/ha or more, 8 g ai/ha or more, 9 g ai/ha or more, 10 g ai/ha or more, 12.5 g ai/ha or more, 15 g ai/ha or more, 17.5 g ai/ha or more, 20 g ai/ha or more, 22.5 g ai/ha or more, 25 g ai/ha or more, 27.5 g ai/ha or more, 30 g ai/ha or more, 32.5 g ai/ha or more, 35 g ai/ha or more, 37.5 g ai/ha or more, 40 g ai/ha or more, 45 g ai/ha or more, 50 g ai/ha or more, 60 g ai/ha or more, 70 g ai/ha or more, or 75 g ai/ha or more; in an amount of 80 g ai/ha or less, such as 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 37.5 g ai/ha or less, 35 g ai/ha or less, 32.5 g ai/ha or less, 30 g ai/ha or less, 27.5 g ai/ha or less, 25 g ai/ha or less, 22.5 g ai/ha or less, 20 g ai/ha or less, 17.5 g ai/ha or less, 15 g ai/ha or less, 12.5 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3 g ai/ha or less, 2 g ai/ha or less, 1 g ai/ha or less, 0.8 g ai/ha or less, or 0.6 g ai/ha or less; or in an amount ranging from any of the minimum values described above to any of the maximum values described above, such as 0.5-80 g ai/ha, 30-75 g ai/ha, 6-70 g ai/ha, 10-65 g ai/ha, 20-50 g ai/ha, 15-80 g ai/ha, 3-45 g ai/ha, 12.5-37.5 g ai/ha, 7-35 g ai/ha, 9-32.5 g ai/ha, 1-25 g ai/ha, 8-65 g ai/ha, 4-22.5 g ai/ha, 0.5-20 g ai/ha, 0.8-17.5 g ai/ha, 22.5-55 g ai/ha, 10-40 g ai/ha, 0.5-5 g ai/ha, or 0.6-75 g ai/ha.

IV. Compositions

In some aspects, a composition comprising florpyrauxifen, an agriculturally acceptable salt or ester thereof, or combinations thereof, may be mixed with or applied in combination with a second herbicide, which may be selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof.

In some aspects, the composition may further comprise a third herbicide selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof.

In some aspects, the composition may further comprise a fourth herbicide selected from (a) 2,4-D or agriculturally acceptable salts or esters thereof or combinations thereof, (b) amidosulfuron or agriculturally acceptable salts or esters thereof or combinations thereof, or (c) saflufenacil or agriculturally acceptable salts or esters thereof or combinations thereof.

In some aspects, florpyrauxifen and the second herbicide (or third herbicide or fourth herbicide) may be used in an amount sufficient to induce an unexpectedly enhanced herbicidal effect (e.g., increased damage or injury to undesirable vegetation) while showing a safening effect toward white clover (e.g., less than expected damage or injury to white clover) when compared to the individual application of florpyrauxifen or to the individual application of the second herbicide (or third herbicide or fourth herbicide).

In some aspects exemplified herein, the damage or injury to undesirable vegetation caused by the compositions and methods disclosed herein is evaluated using a scale from 0% to 100%, when compared with the untreated control vegetation, wherein 0% indicates no damage to the undesirable vegetation and 100% indicates complete destruction of the undesirable vegetation. Similarly, in some aspects, the damage or injury to the desirable vegetation (e.g., white clover) caused by the compositions and methods disclosed herein is evaluated using a scale from 0% to 100%, when compared with untreated control vegetation, wherein 0% indicates no damage to the desirable vegetation and 100% indicates complete destruction of the desirable vegetation.

In some aspects exemplified herein, the Colby equation is applied to determine whether using florpyrauxifen and the second herbicide in combination shows a unexpected effect:

$$E = X + Y - \frac{X * Y}{100}$$

wherein
X=effect in percent using (a) florpyrauxifen, an agriculturally acceptable salt or ester thereof, or a combination thereof at an application rate a;
Y=effect in percent using (b) the second herbicide at an application rate b;
E=expected effect (in %) of (a)+(b) at application rates a and b.
   Similarly, the Colby equation may be used to determine any unexpected effects of using florpyrauxifen, the second herbicide, and the optional third herbicide or fourth herbicide.

In the Colby equation, the value E corresponds to the effect (plant damage or injury) that is to be expected if the activity of the individual compounds is additive. With respect to the undesirable vegetation, if the observed effect is higher than the value E calculated according to the Colby equation, then an unexpectedly enhanced herbicidal effect is present according to the Colby equation. Likewise, with respect to desirable vegetation, such as white clover, if the observed effect is lower than the value E calculated according to the Colby equation, then an unexpected safening effect is present according to the Colby equation with respect to the desirable vegetation.

In some aspects, the joint action of florpyrauxifen and the second herbicide results in unexpectedly enhanced herbicidal effect against undesirable vegetation, even at application rates below those typically used for the herbicide to have a herbicidal effect on its own. In some aspects, the compositions and methods disclosed herein can, based on the individual components, be used at lower application rates to achieve a herbicidal effect comparable to the effect produced by the individual components at normal application rates.

In some aspects, the weight ratio of florpyrauxifen, an agriculturally acceptable salt or ester thereof, or combinations thereof (in g ae/ha) to a second herbicide selected from 2,4-D, an agriculturally acceptable salt or ester thereof, or combinations thereof (in g ae/ha) is 1:1500 or more, such as 1:1400 or more, 1:1300 or more, 1:1200 or more, 1:1100 or more, 1:1000 or more, 1:900 or more, 1:800 or more, 1:700 or more, 1:600 or more, 1:500 or more, 1:400 or more, 1:300 or more, 1:200 or more, 1:150 or more, 1:110 or more, 1:100 or more, 1:90 or more, 1:85 or more, 1:80 or more, 1:75 or more, 1:70 or more, 1:60 or more, 1:56 or more, 1:55 or more, 1:50 or more, 1:40 or more, 1:30 or more, 1:25 or more, 1:20 or more, 1:19 or more, 1:18 or more, 1:17 or more, 1:16 or more, 1:15 or more, 1:14 or more, 1:13 or more, 1:12 or more, 1:11 or more, 1:10 or more, or 1:9 or more; the weight ratio is 1:8 or less, such as 1:9 or less, 1:10 or less, 1:11 or less, 1:12 or less, 1:13 or less, 1:14 or less, 1:15 or less, 1:16 or less, 1:17 or less, 1:18 or less, 1:19 or less, 1:20 or less, 1:25 or less, 1:30 or less, 1:40 or less, 1:50 or less, 1:55 or less, 1:56 or less, 1:60 or less, 1:70 or less, 1:75 or less, 1:80 or less, 1:85 or less, 1:90 or less, 1:100 or less, 1:110 or less, 1:150 or less, 1:200 or less, 1:300 or less, 1:400 or less, 1:500 or less, 1:600 or less, 1:700 or less, 1:800 or less, 1:900 or less, 1:1000 or less, 1:1100 or less, 1:1200 or less, 1:1300 or less, or 1:1400 or less; or the weight ratio can range from any of the minimum ratios to any of the maximum ratios provided above, such as from 1:1500 to 1:8, from 1:500 to 1:14, from 1:40 to 1:10, from 1:110 to 1:56, from 1:900 to 1:11, or from 1:100 to 1:85.

In some aspects, the weight ratio of florpyrauxifen, an agriculturally acceptable salt or ester thereof, or combinations thereof (in g ae/ha) to a second herbicide selected from amidosulfuron, an agriculturally acceptable salt or ester thereof, or combinations thereof (in g ae/ha) is 1:60 or more, such as 1:59 or more, 1:58 or more, 1:57 or more, 1:56 or more, 1:55 or more, 1:50 or more, 1:45 or more, 1:40 or more, 1:35 or more, 1:30 or more, 1:25 or more, 1:20 or more, 1:17.5 or more, 1:15 or more, 1:12.5 or more, 1:10 or more, 1:9 or more, 1:8 or more, 1:7.5 or more, 1:7 or more, 1:6 or more, 1:5 or more, 1:4 or more, 1:3 or more, 1:2.5 or more, 1:2 or more, 1:1.5 or more, 1:1.25 or more, 1:1.1 or more, 1:1 or more, 1.1:1 or more, 1.25:1 or more, 1.5:1 or more, 2:1 or more, or 2.5:1 or more; the weight ratio is 3:1 or less, such as 2.5:1 or less, 2:1 or less, 1.5:1 or less, 1.25:1 or less, 1.1:1 or less, 1:1 or less, 1:1.1 or less, 1:1.25 or less, 1:1.5 or less, 1:2 or less, 1:2.5 or less, 1:3 or less, 1:4 or less, 1:5 or less, 1:6 or less, 1:7 or less, 1:7.5 or less, 1:8 or less, 1:9 or less, 1:10 or less, 1:12.5 or less, 1:15 or less, 1:17.5 or less, 1:20 or less, 1:25 or less, 1:30 or less, 1:35 or less, 1:40 or less, 1:45 or less, 1:50 or less, 1:55 or less, 1:56 or less, 1:57 or less, 1:58 or less, or 1:59 or less; or the weight ratio can range from any of the minimum ratios to any of the maximum ratios provided above, such as from 1:60 to 3:1, from 1:50 to 1:15, from 2:1 to 1:6, from 1:20 to 1:5, from 1:9 to 1:35, or from 1.5:1 to 1:59.

In some aspects, the weight ratio of florpyrauxifen, an agriculturally acceptable salt or ester thereof, or combinations thereof (in g ae/ha) to a second herbicide selected from saflufenacil, an agriculturally acceptable salt or ester thereof, or combinations thereof (in g ae/ha) is 1:80 or more, such as 1:79 or more, 1:78 or more, 1:77 or more, 1:76 or more, 1:75 or more, 1:70 or more, 1:65 or more, 1:60 or more, 1:55 or more, 1:50 or more, 1:45 or more, 1:40 or more, 1:35 or more, 1:30 or more, 1:25 or more, 1:20 or more, 1:17.5 or more, 1:15 or more, 1:12.5 or more, 1:10 or more, 1:9 or more, 1:8 or more, 1:7.5 or more, 1:7 or more, 1:6 or more, 1:5 or more, 1:4 or more, 1:3 or more, 1:2.5 or more, 1:2 or more, 1:1.5 or more, 1:1.25 or more, 1:1 or more, 1.25:1 or more, 1.5:1 or more, 2:1 or more, 2.5:1 or more, 3:1 or more, 4:1 or more, 5:1 or more, 6:1 or more, 7:1 or more, 7.5:1 or more, 8:1 or more, 9:1 or more, 10:1 or more, 12.5:1 or more, 15:1 or more, 17.5:1 or more, 20:1 or more, 25:1 or more, 30:1 or more, 35:1 or more, 40:1 or more, 45:1 or more, 50:1 or more, 52.5:1 or more, 55:1 or more, 56:1 or more, 57:1 or more, 57.5:1 or more, 58:1 or more, or 59:1 or more; the weight ratio is 60:1 or less, such as 59:1 or less, 58:1 or less, 57.5:1 or less, 57:1 or less, 56:1 or less, 55:1 or less, 52.5:1 or less, 50:1 or less, 45:1 or less, 40:1 or less, 35:1 or less, 30:1 or less, 25:1 or less, 20:1 or less, 17.5:1 or less, 15:1 or less, 12.5:1 or less, 10:1 or less, 9:1 or less, 8:1 or less, 7.5:1 or less, 7:1 or less, 6:1 or less, 5:1 or less, 4:1 or less, 3:1 or less, 2.5:1 or less, 2:1 or less, 1.5:1 or less, 1.25:1 or less, 1:1 or less, 1:1.25 or less, 1:1.5 or less, 1:2 or less, 1:2.5 or less, 1:3 or less, 1:4 or less, 1:5 or less, 1:6 or less, 1:7 or less, 1:7.5 or less, 1:8 or less, 1:9 or less, 1:10 or less, 1:12.5 or less, 1:15 or less, 1:17.5 or less, 1:20 or less, 1:25 or less, 1:30 or less, 1:35 or less, 1:40 or less, 1:45 or less, 1:50 or less, 1:55 or less, 1:60 or less, 1:65 or less, 1:70 or less, 1:75 or less, 1:76 or less, 1:77 or less, 1:78 or less, or 1:79 or less; or the weight ratio can range from any of the minimum ratios to any of the maximum ratios provided above, such as from 1:80 to 60:1, from 1:70 to 15:1, from 25:1 to 6:1, from 1:20 to 1:5, from 1:79 to 1:35, or from 35:1 to 1:55.

In some aspects, the composition may comprise a third herbicide. In some aspects, the weight ratio of florpyrauxifen, an agriculturally acceptable salt or ester thereof, or combinations thereof (in g ae/ha) to a second herbicide selected from 2,4-D, an agriculturally acceptable salt or ester thereof, or combinations thereof (in g ae/ha) to a third herbicide selected from amidosulfuron, an agriculturally acceptable salt or ester thereof, or combinations thereof (in g ae/ha) can range from any of the minimum ratios to any of the maximum ratios provided above, such as from 1:1500:60 to 1:8:0.33, from 1:500:50 to 1:14:15, from 1:40:0.5 to 1:10:6, from 1:110:20 to 1:56:6, from 1:900:9 to 1:11:35, or from 1:100:1 to 1:85:59. In some aspects, the weight ratio of florpyrauxifen, an agriculturally acceptable salt or ester thereof, or combinations thereof (in g ae/ha) to a second herbicide selected from 2,4-D, an agriculturally acceptable salt or ester thereof, or combinations thereof (in g ae/ha) to a third herbicide selected from saflufenacil, an agriculturally acceptable salt or ester thereof, or combinations thereof (in g ae/ha) can range from any of the minimum ratios to any of the maximum ratios provided above, such as from 1:1500:80 to 60:480:1, from 1:500:50 to 1:150:25, from 1:40:20 to 1:10:6, from 1:110:20 to 20:56:1, from 1:900:9 to 1:11:35, or from 1:100:1 to 1:85:79. In some aspects, the weight ratio of florpyrauxifen, an agriculturally acceptable salt or ester thereof, or combinations thereof (in g ae/ha) to a second herbicide selected from amidosulfuron, an agriculturally acceptable salt or ester thereof, or combinations thereof (in g ae/ha) to a third herbicide selected from saflufenacil, an agriculturally acceptable salt or ester thereof, or combinations thereof (in g ae/ha) can range from any of the minimum ratios to any of the maximum ratios provided above, such as from 1:60:80 to 60:20:1, from 1:30:50 to 3:14:1, from 1:40:55 to 50:17.5:30, from 1:11:20 to 1:6:6, from 1:30:9 to 1:11:4, or from 1:59:79 to 15:5:1.

In some aspects, the active ingredients in the compositions disclosed herein consist of florpyrauxifen, an agriculturally acceptable salt or ester thereof, or combinations thereof, and a second herbicide selected from 2,4-D, an agriculturally acceptable salt or ester thereof, or combinations thereof. In some aspects, the active ingredients in the compositions disclosed herein consist of florpyrauxifen, an agriculturally acceptable salt or ester thereof, or combinations thereof, and a second herbicide selected from amidosulfuron, an agriculturally acceptable salt or ester thereof, or combinations thereof. In some aspects, the active ingredients in the compositions disclosed herein consist of florpyrauxifen, an agriculturally acceptable salt or ester thereof, or combinations thereof, and a second herbicide selected from saflufenacil, an agriculturally acceptable salt or ester thereof, or combinations thereof. In some aspects, the active ingredients in the compositions disclosed herein consist of florpyrauxifen, an agriculturally acceptable salt or ester thereof, or combinations thereof, a second herbicide selected from 2,4-D, amidosulfuron, saflufenacil, agriculturally acceptable salts or esters thereof, or combinations thereof, and a third herbicide selected from 2,4-D, amidosulfuron, saflufenacil, agriculturally acceptable salts or esters thereof, or combinations thereof. In some aspects, the active ingredients in the compositions disclosed herein consist of agriculturally acceptable acids, salts or esters of florpyrauxifen, 2,4-D, amidosulfuron, and saflufenacil.

In some aspects, florpyrauxifen, the second herbicide, and the optional third or fourth herbicide, independently, can be employed in a purity of from 90% to 100% (e.g., from 95% to 100%) according to nuclear magnetic resonance (NMR) spectroscopy.

V. Formulations

The present disclosure also includes formulations of the compositions and methods disclosed herein.

A. Additives

The compositions and methods disclosed herein can also be mixed with or applied with an additive. In some aspects, the additive is added sequentially. In some aspects, the additive is added simultaneously. In some aspects, the additive is premixed with the florpyrauxifen or second herbicide.

1. Other Pesticides

Some aspects of the described herbicidal compositions disclosed include adding one or more additional pesticide active ingredients to the herbicidal compositions. These pesticide active ingredients may include one or more of an herbicide, an insecticide, a fungicide, a nematocide, a miticide, a arthropodicide, a bactericide, a plant growth regulator, or combinations thereof that are compatible with the compositions of the present disclosure.

For example, the compositions described herein can be applied in conjunction with one or more additional herbicides to control undesirable vegetation. The composition can be formulated with the one or more additional herbicides, tank mixed with the one or more additional herbicides, or applied sequentially with the one or more additional herbicides. Exemplary additional herbicides include, but are not limited to: 4-CPA; 4-CPB; 4-CPP; 2;4-D; 2;4-D choline salt; 2,4-D salts, esters and amines; 2,4-DB; 3,4-DA; 3,4-DB; 2,4-DEB; 2,4-DEP; 2,4-DP; 3,4-DP; 2,3,6-TBA; 2,4,5-T; 2,4,5-TB; acetochlor; acifluorfen; aclonifen; acrolein; alachlor; allidochlor; alloxydim; allyl alcohol; alorac; ametridione; ametryne; amibuzin; amicarbazone; amidosulfuron; aminocyclopyrachlor; 4-aminopicolinic acid based herbicides, such as halauxifen, halauxifen-methyl, florpyrauxifen, and those described in U.S. Pat. Nos. 7,314,849 and 7,432,227 to Balko, et al.; aminopyralid; amiprofos-methyl; amitrole; ammonium sulfamate; anilofos; anisuron; asulam; atraton; atrazine; azafenidin; azimsulfuron; aziprotryne; barban; BCPC; beflubutamid; benazolin; bencarbazone; benfluralin; benfuresate; bensulide; bensulfuron; benthiocarb; bentazone; benzadox; benzfendizone; benzipram; benzobicyclon; benzofenap; benzofluor; benzoylprop; benzthiazuron; bialaphos; bicyclopyrone; bifenox; bilanafos; bispyribac; borax; bromacil; bromobonil; bromobutide; bromofenoxim; bromoxynil; brompyrazon; butachlor; butafenacil; butamifos; butenachlor; buthidazole; buthiuron; butralin; butroxydim; buturon; butylate; cacodylic acid; cafenstrole; calcium chlorate; calcium cyanamide; cambendichlor; carbasulam; carbetamide; carboxazole; chlorprocarb; carfentrazone-ethyl; CDEA; CEPC; chlomethoxyfen; chloramben; chloranocryl; chlorazifop; chlorazine; chlorobromuron; chlorbufam; chloreturon; chlorfenac; chlorfenprop; chlorflurazole; chlorflurenol; chloridazon; chlorimuron; chlornitrofen; chloropon; chlorotoluron; chloroxuron; chloroxynil; chlorpropham; chlorsulfuron; chlorthal; chlorthiamid; cinidon-ethyl; cinmethylin; cinosulfuron; cisanilide; clacyfos; clethodim; cliodinate; clodinafop-propargyl; clofop; clomazone; clomeprop; cloprop; cloproxydim; clopyralid; cloransulam-methyl; CMA; copper sulfate; CPMF; CPPC; credazine; cresol; cumyluron; cyanatryn; cyanazine; cycloate; cyclopyrimorate; cyclosulfamuron; cycloxydim; cycluron; cyhalofop-butyl; cyperquat; cyprazine; cyprazole; cypromid; daimuron; dalapon; dazomet; delachlor; desmedipham; desmetryn; di-allate; dicamba; dichlobenil; dichloralurea; dichlormate; dichlorprop; dichlorprop-P; diclofop-methyl; diclosulam; diethamquat; diethatyl; difenopenten; difenoxuron; difenzoquat; diflufenican; diflufenzopyr; dimefuron; dimepiperate; dimethachlor; dimethametryn; dimethenamid; dimethenamid-P; dimexano; dimidazon; dinitramine; dinofenate; dinoprop; dinosam; dinoseb; dinoterb; diphenamid; dipropetryn; diquat; disul; dithiopyr; diuron; DMPA; DNOC; DSMA; EBEP; eglinazine; endothal; epronaz; EPTC; erbon; esprocarb; ethalfluralin; ethametsulfuron; ethbenzamide; ethametsulfuron; ethidimuron; ethiolate; ethobenzamid; ethofumesate; ethoxyfen; ethoxysulfuron; etinofen; etnipromid; etobenzanid; EXD; fenasulam; fenoprop; fenoxaprop; fenoxaprop-P-ethyl; fenoxaprop-P-ethyl+isoxadifen-ethyl; fenoxasulfone; fenquinotrione; fenteracol; fenthiaprop; fentrazamide; fenuron; ferrous sulfate; flamprop; flamprop-M; flazasulfuron; florasulam; fluazifop; fluazifop-P-butyl; fluazolate; flucarbazone; flucetosulfuron; fluchloralin; flufenacet; flufenican; flufenpyr-ethyl; flumetsulam; flumezin; flumiclorac-pentyl; flumioxazin; flumipropyn; fluometuron; fluorodifen; fluoroglycofen; fluoromidine; fluoronitrofen; fluothiuron; flupoxam; flupropacil; flupropanate; flupyrsulfuron; fluridone; flurochloridone; fluroxypyr; fluroxypyr-meptyl; flurtamone; fluthiacet; fomesafen; foramsulfuron; fosamine; fumiclorac; furyloxyfen; glufosinate; glufosinate-ammonium; glufosinate-P-ammonium; glyphosate salts and esters; halosafen; halosulfuron; haloxydine; haloxyfop; hexachloroacetone; hexaflurate; hexazinone; imazamethabenz; imazamox; imazapic; imazapyr; imazaquin; imazethapyr; imazosulfuron; indanofan; indaziflam; iodobonil; iodomethane; iodosulfuron; iodosulfuron-ethyl-sodium; iofensulfuron; ioxynil; ipazine; ipfencarbazone; iprymidam; isocarbamid; isocil; isomethiozin; isonoruron; isopolinate; isopropalin; isoproturon; isouron; isoxaben; isoxachlortole; isoxaflutole; isoxapyrifop; karbutilate; ketospiradox; lactofen; lenacil; linuron; MAA; MAMA; MCPA esters and amines; MCPA-thioethyl; MCPB; mecoprop; mecoprop-P; medinoterb; mefenacet; mefluidide; mesoprazine; mesosulfuron; mesotrione; metam; metamifop; metamitron; metazachlor; metflurazon; methabenzthiazuron; methalpropalin; methazole; methiobencarb; methiozolin; methiuron; methometon; methoprotryne; methyl bromide; methyl isothiocyanate; methyldymron; metobenzuron; metobromuron; metolachlor; metosulam; metoxuron; metribuzin; metsulfuron; molinate; monalide; monisouron; monochloroacetic acid; monolinuron; monuron; morfamquat; MSMA; naproanilide; napropamide; napropamide-M; naptalam; neburon; nicosulfuron; nipyraclofen; nitralin; nitrofen; nitrofluorfen; norflurazon; noruron; OCH; orbencarb; ortho-dichlorobenzene; orthosulfamuron; oryzalin; oxadiargyl; oxadiazon; oxapyrazon; oxasulfuron; oxaziclomefone; oxyfluorfen; paraflufen-ethyl; parafluron; paraquat; pebulate; pelargonic acid; pendimethalin; penoxsulam; pentachlorophenol; pentanochlor; pentoxazone; perfluidone; pethoxamid; phenisopham; phenmedipham; phenmedipham-ethyl; phenobenzuron; phenylmercury acetate; picloram; picolinafen; pinoxaden; piperophos; potassium arsenite; potassium azide; potassium cyanate; pretilachlor; primisulfuron; procyazine; prodiamine; profluazol; profluralin; profoxydim; proglinazine; prohexadione-calcium; prometon; prometryne; pronamide; propachlor; propanil; propaquizafop; propazine; propham; propisochlor; propoxycarbazone; propyrisulfuron; propyzamide; prosulfalin; prosulfocarb; prosulfuron; proxan; prynachlor; pydanon; pyraclonil; pyraflufen; pyrasulfotole; pyrazogyl; pyrazone; pyrazolynate; pyrazosulfuron; pyrazoxyfen; pyribenzoxim; pyributicarb; pyriclor; pyridafol; pyridate; pyriftalid; pyriminobac; pyrimisulfan; pyrithiobac-sodium; pyroxasulfone; pyroxsulam; quinclorac; quinmerac; quinoclamine; quinonamid; quizalofop; quizalofop-P-ethyl; quizalofop-P-tefuryl; rhodethanil; rimsulfuron; saflufenacil; S-metolachlor; sebuthylazine; secbumeton; sethoxydim; siduron; simazine; simeton; simetryn; SMA; sodium arsenite; sodium azide; sodium chlorate; sulcotrione; sulfallate; sulfentrazone; sulfometuron; sulfosate; sulfosulfuron; sulfuric acid; sulglycapin; swep; TCA; tebutam; tebuthiuron; tefuryltrione; tembotrione; tepraloxydim; terbacil; terbucarb; terbuchlor; terbumeton; terbuthylazine; terbutryne; tetrafluron; thenylchlor; thiameturon; thiazafluron; thiazopyr; thidiazimin; thidiazuron; thiencarbazone; thifensulfuron; thiobencarb; tiafenacil; tiocarbazil; tioclorim; tolpyralate; topramezone; tralkoxydim; tri-allate; triafamone; triasulfuron; triaziflam; tribenuron; tribenuron; tricamba; triclopyr choline salt; triclopyr esters and amines; tridiphane; trietazine; trifloxysulfuron; trifludimoxazin; trifluralin; triflusulfuron; trifop; trifopsime; trihydroxytriazine; trimeturon; tripropindan; tritac; tritosulfuron; vernolate; xylachlor; and salts, esters, optically active isomers, and mixtures thereof.

In some aspects, the additional pesticide or an agriculturally acceptable salt or ester thereof is provided in a premixed formulation with florpyrauxifen, the second herbicide, or combinations thereof. In some aspects, the florpyrauxifen, an agriculturally acceptable salt or ester thereof, or combinations thereof is provided in a premixed formulation with an additional pesticide. In some aspects, the second herbicide, an agriculturally acceptable salt or ester thereof, or a combination thereof is provided in a premixed formulation with an additional pesticide.

In some aspects, the compositions may include one or more herbicidal active ingredients in addition to florpyrauxifen and the second herbicide. In some aspects, the compositions do not include an herbicidal active ingredient in addition to florpyrauxifen and the second herbicide. In some aspects, the compositions may exclude one or more herbicidal active ingredients specified above. In some aspects, the compositions may include one or more herbicidal active ingredients in addition to florpyrauxifen and second herbicide, but may exclude one or more herbicidal ingredients specified above.

2. Adjuvants

In some aspects, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, adhesives (for instance, for use in seed formulations), surfactants, protective colloids, emulsifiers, tackifiers, and mixtures thereof.

Exemplary agriculturally acceptable adjuvants include, but are not limited to, crop oil concentrates (e.g., 85% mineral oil+15% emulsifiers); nonylphenol ethoxylates; benzylcocoalkyldimethyl quaternary ammonium salts; blends of petroleum hydrocarbon, alkyl esters, organic acids, and anionic surfactants; C₉-C₁₁ alkylpolyglycoside; phosphate alcohol ethoxylates; natural primary alcohol (C₁₂-C₁₆) ethoxylate; di-sec-butylphenol EO-PO block copolymers; polysiloxane-methyl cap; nonylphenol ethoxylate+urea ammonium nitrates; emulsified methylated seed oils; tridecyl alcohol (synthetic) ethoxylates (e.g., 8 EO); tallow amine ethoxylates (e.g., 15 EO); and PEG(400) dioleate-99.

Exemplary surfactants (e.g., wetting agents, tackifiers, dispersants, emulsifiers) include, but are not limited to: the alkali metal salts, alkaline earth metal salts and ammonium salts of fatty acids or of aromatic sulfonic acids (e.g., lignosulfonic acids, phenolsulfonic acids, naphthalenesulfonic acids, and dibutylnaphthalenesulfonic acid); alkyl- and alkylarylsulfonates; alkyl sulfates, lauryl ether sulfates and fatty alcohol sulfates; salts of sulfated hexa-, hepta- and octadecanols; salts of fatty alcohol glycol ethers; condensates of sulfonated naphthalene and its derivatives with formaldehyde; condensates of naphthalene or of the naphthalene sulfonic acids with phenol and formaldehyde; polyoxyethylene octylphenol ether; ethoxylated isooctyl-, octyl- or nonylphenol, alkylphenyl or tributylphenyl polyglycol ether; alkyl aryl polyether alcohols; isotridecyl alcohol; fatty alcohol/ethylene oxide condensates; ethoxylated castor oil; polyoxyethylene alkyl ethers or polyoxypropylene alkyl ethers; lauryl alcohol polyglycol ether acetate; sorbitol esters; lignosulfite waste liquors and proteins; denatured proteins, polysaccharides (e.g., methylcellulose); hydrophobically modified starches; and polyvinyl alcohol, polycarboxylates, polyalkoxylates, polyvinyl amine, polyethyleneimine, polyvinylpyrrolidone, and copolymers thereof.

Exemplary thickeners include, but are not limited to, polysaccharides (e.g., xanthan gum), organic and inorganic sheet minerals, and mixtures thereof.

Exemplary antifoam agents include, but are not limited to, silicone emulsions, long-chain alcohols, fatty acids, fatty acid salts, organofluorine compounds, and mixtures thereof.

Exemplary antimicrobial agents include, but are not limited to: bactericides based on dichlorophen and benzyl alcohol hemiformal; isothiazolinone derivatives, such as alkylisothiazolinones and benzisothiazolinones; and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

3. Safeners

In some aspects, the additive is a safener. Safeners are compounds leading to better crop plant compatibility when applied with a herbicide. In some aspects, the safener itself is herbicidally active. In some aspects, the safener acts as an antidote or antagonist in the crop plants and can protect the crop plants from damage that might otherwise occur from an applied herbicide. Exemplary safeners include, but are not limited to, AD-67 (MON 4660), benoxacor, benthiocarb, brassinolide, cloquintocet-mexyl, cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, naphthalic anhydride, 2,2,5-trimethyl-3-(dichloroacetyl)-1,3-oxazolidine, 4-(dichloroacetyl)-1-oxa-4-azaspiro [4.5]decane, oxabetrinil, R29148, and N-phenyl-sulfonylbenzoic acid amides, as well as thereof agriculturally acceptable salts and, provided they have a carboxyl group, their agriculturally acceptable derivatives. In some aspects, the safener can be cloquintocet or an ester or salt thereof, such as cloquintocet-mexyl. In some aspects, the safener can be mefenpyr-diethyl. In some aspects, the safener is employed in rice, cereal, or maize. For example, cloquintocet-mexyl or mefenpyr-diethyl can be used to antagonize harmful effects of the compositions on rice, row crops, and cereals.

4. Carriers

In some aspects, the additive includes a carrier. In some aspects, the additive includes a liquid or solid carrier. In some aspects, the additive includes an organic or inorganic carrier. Exemplary liquid carriers include, but are not limited to: water; petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like; toluene; xylene; petroleum naphtha; crop oil; acetone; methyl ethyl ketone; cyclohexanone; trichloroethylene; perchloroethylene; ethyl acetate; amyl acetate; butyl acetate; propylene glycol monomethyl ether and diethylene glycol monomethyl ether; methyl alcohol; ethyl alcohol; isopropyl alcohol; amyl alcohol; ethylene glycol; propylene glycol; glycerin; N-methyl-2-pyrrolidinone; N;N-dimethyl alkylamides; dimethyl sulfoxide; and liquid fertilizers, as well as mixtures thereof. Exemplary solid carriers include, but are not limited to: solid fertilizers, silicas, silica gels, silicates, talc, kaolin, limestone, lime, chalk, bole, Ioess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

B. Physical States

In some aspects, the formulation of florpyrauxifen and the second herbicide may be present in suspended, emulsified, dissolved, or solid form. Exemplary formulations include, but are not limited to, aqueous solutions, aqueous suspensions, aqueous dispersions, aqueous emulsions, aqueous microemulsions, aqueous suspo-emulsions, oil solutions, oil suspensions, oil dispersions, oil emulsions, oil microemulsions, oil suspo-emulsions, self-emulsifying formulations, pastes, powders, dusts, granules, and materials for spreading.

In some aspects, florpyrauxifen and the second herbicide may be aqueous solutions that can be diluted before use. In various aspects, florpyrauxifen and the second herbicide may be provided as a high-strength formulation such as a concentrate. In some aspects, the concentrate is stable and retains potency during storage and shipping. In various aspects, the concentrate may be a clear, homogeneous liquid that is stable at temperatures of 54° C. or greater. In some aspects, the concentrate does not exhibit any precipitation of solids at temperatures of −10° C. or higher. In some aspects, the concentrate does not exhibit separation, precipitation, or crystallization of any components at low temperatures (e.g., below −5° C., below −10° C., or below −15° C.). In some aspects, the concentrate exhibits a viscosity of less than 50 centipoise (50 megapascals), even at temperatures as low as 5° C. In some aspects, the concentrate does not exhibit separation, precipitation, or crystallization of any components during storage for a period of 2 weeks or greater (e.g., 4 weeks, 6 weeks, 8 weeks, 3 months, 6 months, 9 months, or 12 months or greater).

In some aspects, emulsions, pastes, or oil dispersions can be prepared by homogenizing florpyrauxifen and the second herbicide in water with a wetting agent, tackifier, dispersant, or emulsifier. In some aspects, concentrates suitable for dilution with water can be prepared, comprising florpyrauxifen, the second herbicide, a wetting agent, a tackifier, and a dispersant or emulsifier.

In some aspects, powders, materials for spreading, or dusts can be prepared by mixing or concomitant grinding of florpyrauxifen and the second herbicide and optionally other additives with a solid carrier.

In some aspects, granules (e.g., coated granules, impregnated granules and homogeneous granules) can be prepared by binding florpyrauxifen and the second herbicide to solid carriers.

In some aspects, the formulations comprise, by total weight of florpyrauxifen and the second herbicide, from 1% to 99% of florpyrauxifen and 1% to 99% of the second herbicide (e.g., 95% of florpyrauxifen and 5% of the second herbicide; 70% of florpyrauxifen and 30% of the second herbicide; or 40% of florpyrauxifen and 60% of the second herbicide). In formulations designed to be employed as concentrates, the total amount of florpyrauxifen and the second herbicide can be present in a concentration of from about 0.1 to about 98 weight percent (wt. %), based on the total weight of the formulation. For example, the total amount of florpyrauxifen and the second herbicide can be present in a concentration as little as about 1 wt. %, about 2.5 wt. %, about 5 wt. %, about 7.5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, about 97 wt. %, or within any range defined between any two of the forgoing values, such as between about 1 wt. % to about 97 wt. %, between about 10 wt. % to about 90 wt. %, between about 20 wt. % to about 45 wt. %, and about 25 wt. % to about 50 wt. % based on the total weight of the formulation. Concentrates can be diluted with an inert carrier, such as water, prior to application. The diluted formulations applied to undesirable vegetation or the locus of undesirable vegetation can contain from 0.0006 to 8.0 wt. % of the total amount of florpyrauxifen and the second herbicide (e.g., from 0.001 to 5.0 wt. %), based on the total weight of the diluted formulation.

C. Packaging

In some aspects, the formulation can be in the form of a single package formulation including both florpyrauxifen and the second herbicide. In some aspects, the formulation can be in the form of a single package formulation including both florpyrauxifen and the second herbicide, and further including at least one additive. In some aspects, the formulation can be in the form of a multi-package formulation, such as a two-package formulation, wherein one package contains florpyrauxifen and optionally at least one additive while the other package contains the second herbicide and optionally at least one additive. In some aspects of the two-package formulation, the formulation including florpyrauxifen and optionally at least one additive and the formulation including the second herbicide and optionally at least one additive are mixed before application and then applied simultaneously. In some aspects, the mixing is performed as a tank mix (e.g., the formulations are mixed immediately before or upon dilution with water). In some aspects, the formulation including florpyrauxifen and the formulation including the second herbicide are not mixed but are applied sequentially (in succession), for example, immediately or within 1 hour, within 2 hours, within 4 hours, within 8 hours, within 16 hours, within 24 hours, within 2 days, or within 3 days, of each other.

VI. Methods of Use

The compositions disclosed herein can be applied in any known technique for applying herbicides. Exemplary application techniques include, but are not limited to, spraying, atomizing, dusting, spreading, or direct application into water. The method of application can vary depending on the intended purpose. In some aspects, the method of application can be chosen to ensure the finest possible distribution of the compositions disclosed herein.

In some aspects, a method of controlling undesirable vegetation which comprises contacting the vegetation or the locus thereof with or applying to the soil or water to prevent the emergence or growth of vegetation any of the compositions is disclosed herein.

The compositions disclosed herein can be applied pre-emergence (before the emergence of undesirable vegetation) or post-emergence (e.g., during and/or after emergence of the undesirable vegetation). In some aspects, the composition is applied post-emergence to the undesirable vegetation. In some aspects, florpyrauxifen and the second herbicide are applied simultaneously. In some aspects, florpyrauxifen and the second herbicide are applied sequentially, for example, immediately or with minimal delay, within about 10 minutes, within about 20 minutes, within about 30 minutes, within about 40 minutes, within about 1 hour, within about 2 hours, within about 4 hours, within about 8 hours, within about 16 hours, within about 24 hours, within about 2 days, or within about 3 days, of each other.

In some aspects, the compositions disclosed herein are applied to vegetation or an area adjacent the vegetation or applying to soil or water to prevent the emergence or growth of vegetation by spraying (e.g., foliar spraying). In some aspects, the spraying techniques use, for example, water as carrier and spray volume rates of from 2 liters per hectare (L/ha) to 2000 L/ha (e.g., from 10-1000 L/ha or from 50-500 L/ha). In some aspects, the compositions disclosed herein are applied by the low-volume or the ultra-low-volume method, wherein the application is in the form of micro granules. In some aspects, wherein the compositions disclosed herein are less well tolerated by certain desirable vegetation, the compositions can be applied with the aid of the spray apparatus in such a way that they come into little contact, if any, with the leaves of the desirable vegetation while reaching the leaves of undesirable vegetation that grows underneath or on the bare soil (e.g., post-directed or lay-by). In some aspects, the compositions disclosed herein can be applied as dry formulations (e.g., granules, powders, or dusts).

In some aspects, wherein the undesirable vegetation is treated post-emergence, the compositions disclosed herein are applied by foliar application. In some aspects, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some aspects, these and other factors can be adjusted to promote non-selective or selective herbicidal action.

The compositions and methods disclosed herein can be used to control undesirable vegetation in a variety of applications. The compositions and methods disclosed herein can be used for controlling undesirable vegetation in areas including, but not limited to, pastures, grasslands, rangelands, fallow land, farmland, turfgrass, rights-of-way, aquatic settings, tree and vine orchards, natural areas, wildlife habitat, and other non-crop land areas. In some aspects, the undesirable vegetation is controlled in a pasture or rangeland. In some aspects, the compositions and methods disclosed herein can be used in industrial vegetation management (IVM) or for utility, pipeline, roadside, and railroad rights-of-way applications. In some aspects, the compositions and methods disclosed herein can also be used in forestry (e.g., for site preparation or for combating undesirable vegetation in plantation forests). In some aspects, the compositions and methods disclosed herein can be used to control undesirable vegetation in conservation reserve program lands (CRP), trees, vines, grasslands, and grasses grown for seeds. In some aspects, the compositions and methods disclosed herein can be used on lawns (e.g., residential, industrial, and institutional), golf courses, parks, cemeteries, athletic fields, and sod farms.

In some aspects, the compositions disclosed herein can be used for controlling undesirable vegetation including grasses, broadleaf weeds, sedge weeds, and combinations thereof. In some aspects, the compositions disclosed herein can be used for controlling undesirable vegetation including, but not limited to, Polygonum species, Amaranthus species, Chenopodium species, Sida species, Ambrosia species, Cyperus species, Setaria species, Sorghum species, Acanthospermum species, Anthemis species, Atriplex species, Brassica species, Centaurea species, Cirsium species, Convolvulus species, Conyza species, Cassia species, Commelina species, Datura species, Euphorbia species, Geranium species, Galinsoga species, Helenium species, Ipomea species, Iva species, Lamium species, Lepidium species, Lolium species, Malva species, Matricaria species, Melilotus species, Prosopis species, Ranunculus species, Rumex species, Senna species, Sisymbrium species, Solanum species, Solidago species, Symphyotrichum species, Xanthium species, Veronica species, and Viola species. In some aspects, the undesired vegetation includes velvetleaf (Abutilon theophrasti), Anoda cristata, field chamomile (Anthemis arvensis), mayweed chamomile (Anthemis cotula), Bidens pilosa, Brassica kaber, shepherd's purse (Capsella bursa-pastoris), cornflower (Centaurea cyanus or Cyanus segetum), brown knapweed (Centaurea jacea), Desmodium tortuosum, hempnettle (Galeopsis tetrahit), cleavers (Galium aparine), bitter sneezeweed (Helenium amarum), common sunflower (Helianthus annuus), annual marsh-elder (Iva annua), Virginia pepperweed (Lepidium virginicum), Italian ryegrass (Lolium multiflorum), kochia (Kochia scoparia), Medicago arabica, Mercurialis annua, annual yellow sweetclover (Melilotus indicus), Myosotis arvensis, common poppy (Papaver rhoeas), tall buttercup (Ranunculus acris), Raphanus raphanistrum, broad-leaf dock (Rumex obtusifolius), Russian thistle (Salsola kali), sickle pod (Senna obtusifolia), hemp sesbania (Sesbania exaltata Cory), wild mustard (Sinapis arvensis), goldenrod (Solidago sp.), Sonchus arvensis, common chickweed (Stellaria media), hairy aster (Symphyotrichum pilosum) Thlaspi arvense, Tagetes minuta, Richardia brasiliensis, Plantago major, Plantago lanceolata, bird's-eye speedwell (Veronica persica), pigweed (Amaranthus retroflexus), winter rape (Brassica napus), lambsquarters (Chenopodium album), thistle (Cirsium arvense), nutsedge (Cyperus esculentus), poinsettia (Euphorbia heterophylla), prickly lettuce (Lactuca serriola), purple deadnettle (Lamium purpureum), wild chamomile (Matricaria chamomilla), false chamomile (Matricaria inodora), common buckwheat (Fagopyrum esculentum), wild buckwheat (Polygonum convulvus), giant foxtail (Setaria faberi), green foxtail (Setaria viridis), common sorghum (Sorghum vulgare), wild pansy (Viola tricolor), or a combination thereof.

The compositions described herein can be used to control herbicide resistant or tolerant weeds. The methods employing the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinylthiobenzoates, triazolopyrimidines, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylates, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialaphos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidindiones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes of action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes of action, and biotypes with multiple resistance or tolerance mechanisms (e.g., target site resistance or metabolic resistance).

By way of non-limiting illustration, examples of some aspects of the present disclosure are given below. Parts and percentages are on a per weight basis unless otherwise indicated.

### EXAMPLES

Field Trial Methodology—Evaluation of Postemergence Herbicidal Effect on Weeds and Safening Effect on White Clover

### Example 1

Field trials were established in multiple states in the United States to evaluate the herbicidal effect of florpyrauxifen benzyl and 2,4-D choline on undesirable vegetation species in existing pasture lands. Trials were designed as randomized complete blocks with four replicates. All trials were established with a minimum plot size of 3 meters (m) by 8 m (width×length). All herbicide treatments were applied post-emergence with applications made to the undesirable vegetation. Herbicides were applied with backpack sprayers using carbon dioxide (CO₂) as a propellant. The sprayers utilized flat fan spray nozzles calibrated to deliver a uniform spray pattern that provided thorough coverage of the foliage using a 187 L/ha spray volume. All treatments were applied with Activator 90 non-ionic surfactant at 0.25% v/v.

Compositions comprising florpyrauxifen benzyl and 2,4-D choline were tested on undesirable vegetation species, including mayweed chamomile (ANTCO, Anthemis cotula), hairy aster (ASTPI, Symphyotrichum pilosum), sickle pod (CASOB, Senna obtusifolia), brown knapweed (CENJA, Centaurea jacea), bitter sneezeweed (HENAM, Helenium amarum), annual marsh-elder (IVAAN, Iva annua), Virginia pepperweed (LEPVI, Lepidium virginicum), annual yellow sweetclover (MEUIN, Melilotus indicus), tall buttercup (RANAC, Ranunculus acris), and goldenrod (SOOSS, Solidago sp.) to determine the efficacy of the compositions on these undesirable vegetation species. The weeds were evaluated on the number of days after application (DAA) given in each table below. Injury to the weeds was assessed visually at several intervals after application as percent overall injury, compared to an untreated control plot. The overall injury assessments were based on visual ratings of growth inhibition, leaf deformity, epinasty, and chlorosis. All treatment results, both for the single product and mixtures, are an average of four replicates.

The results are summarized in Tables 1-14 below. Abbreviations used in these tables are as follows:
DAA=days after application
g ae/ha=grams acid equivalent per hectare
Obs=observed value
Exp=expected value as calculated by Colby's equation
A=difference between observed value and expected value
ANTCO=Anthemis cotula (mayweed chamomile)
ASTPI=Symphyotrichum pilosum (hairy aster)
CASOB=Senna obtusifolia (sickle pod)
CENJA=Centaurea jacea (brown knapweed)
HENAM=Helenium amarum (bitter sneezeweed)
IVAAN=Iva annua (annual marsh-elder)
LEPVI=Lepidium virginicum (Virginia pepperweed)
MEUIN=Melilotus indicus (annual yellow sweetclover)
RANAC=Ranunculus acris (tall buttercup)
SOOSS=Solidago sp. (goldenrod)

TABLE 1
Herbicidal effects (% visual injury) of Florpyrauxifen Benzyl
and 2,4-D Choline on pasture weeds - 10 DAA

| | | Visual Weed Control (%) - | | |
|---|---|---|---|---|
| Florpyrauxifen | 2,4-D | 10 DAA | | |
| Benzyl | Choline | RANAC | | |
| g ae/ha | g ae/ha | Obs | Exp | [symbol] |
| 9.44 | 0 | 0 | — | — |
| 0 | 750 | 8 | — | — |
| 9.44 | 750 | 22 | 8 | 14 |

TABLE 2
Herbicidal effects (% visual injury) of Florpyrauxifen Benzyl
and 2,4-D Choline on pasture weeds - 14 DAA

| | | Visual Weed Control (%) - | | |
|---|---|---|---|---|
| Florpyrauxifen | 2,4-D | 14 DAA | | |
| Benzyl | Choline | ANTCO | | |
| g ae/ha | g ae/ha | Obs | Exp | [symbol] |
| 12.5 | 0 | 10 | — | — |
| 0 | 840 | 30 | — | — |
| 12.5 | 840 | 40 | 37 | 3 |

TABLE 3
Herbicidal effects (% visual injury) of Florpyrauxifen Benzyl
and 2,4-D Choline on pasture weeds-27 DAA

| | | Visual Weed Control (%)- | | |
|---|---|---|---|---|
| Florpyrauxifen | 2,4-D | 27 DAA | | |
| Benzyl | Choline | LEPVI | | |
| g ae/ha | g ae/ha | Obs | Exp | [symbol] |
| 9.5 | 0 | 62 | — | — |
| 12.5 | 0 | 70 | — | — |
| 19 | 0 | 65 | | |
| 0 | 840 | 74 | — | — |
| 9.5 | 840 | 100 | 90 | 10 |
| 12.5 | 840 | 100 | 91 | 9 |
| 19 | 840 | 100 | 91 | 9 |

TABLE 4
Herbicidal effects (% visual injury) of Florpyrauxifen Benzyl and 2,4-D Choline
on pasture weeds - 30 DAA

| Florpyrauxifen | 2,4-D | Visual Weed Control (%) - 30 DAA | | | | | | | | |
|---|---|---|---|---|---|---|---|---|---|---|
| Benzyl | Choline | CASOB | | | HENAM | | | MEUIN | | |
| g ae/ha | g ae/ha | Obs | Exp | [symbol] | Obs | Exp | [symbol] | Obs | Exp | [symbol] |
| 9.5 | 0 | — | — | — | 60 | — | — | — | — | — |
| 12.5 | 0 | 10 | — | — | 60 | — | — | — | — | — |
| 19 | 0 | 10 | — | — | — | — | — | 10 | — | — |
| 0 | 840 | 10 | — | — | 74 | — | — | 20 | — | — |
| 9.5 | 840 | — | — | — | 99 | 90 | 9 | — | — | — |
| 12.5 | 840 | 100 | 19 | 81 | 99 | 90 | 9 | — | — | — |
| 19 | 840 | 80 | 19 | 61 | — | — | — | 50 | 28 | 22 |

TABLE 5
Herbicidal effects (% visual injury) of Florpyrauxifen Benzyl
and 2,4-D Choline on pasture weeds-40 DAA

| | | Visual Weed Control (%)- | | |
|---|---|---|---|---|
| Florpyrauxifen | 2,4-D | 40 DAA | | |
| Benzyl | Choline | RANAC | | |
| g ae/ha | g ae/ha | Obs | Exp | [symbol] |
| 9.44 | 0 | 0 | — | — |
| 0 | 750 | 28 | — | — |
| 9.44 | 750 | 79 | 28 | 51 |

TABLE 6
Herbicidal effects (% visual injury) of Florpyrauxifen Benzyl
and 2,4-D Choline on pasture weeds-41 DAA

| | | Visual Weed Control (%)- | | |
|---|---|---|---|---|
| Florpyrauxifen | 2,4-D | 41 DAA | | |
| Benzyl | Choline | IVAAN | | |
| g ae/ha | g ae/ha | Obs | Exp | [symbol] |
| 12.5 | 0 | 38 | — | — |
| 19 | 0 | 50 | — | — |
| 0 | 840 | 38 | — | — |
| 12.5 | 840 | 88 | 61 | 27 |
| 19 | 840 | 96 | 67 | 29 |

TABLE 7
Herbicidal effects (% visual injury) of Florpyrauxifen Benzyl
and 2,4-D Choline on pasture weeds-45 DAA

| | | Visual Weed Control (%)- | | |
|---|---|---|---|---|
| Florpyrauxifen | 2,4-D | 45 DAA | | |
| Benzyl | Choline | CASOB | | |
| g ae/ha | g ae/ha | Obs | Exp | [symbol] |
| 12.5 | 0 | 10 | — | — |
| 19 | 0 | 10 | — | — |
| 0 | 840 | 10 | — | — |
| 12.5 | 840 | 100 | 19 | 81 |
| 19 | 840 | 80 | 19 | 61 |

TABLE 8
Herbicidal effects (% visual injury) of Florpyrauxifen Benzyl
and 2,4-D Choline on pasture weeds-56 DAA

| | | Visual Weed Control (%)- | | |
|---|---|---|---|---|
| Florpyrauxifen | 2,4-D | 56 DAA | | |
| Benzyl | Choline | IVAAN | | |
| g ae/ha | g ae/ha | Obs | Exp | [symbol] |
| 12.5 | 0 | 42 | — | — |
| 0 | 840 | 38 | — | — |
| 12.5 | 840 | 95 | 64 | 31 |

TABLE 9
Herbicidal effects (% visual injury) of Florpyrauxifen Benzyl and
2,4-D Choline on pasture weeds - 67 DAA

| Florpyrauxifen | 2,4-D | Visual Weed Control (%) - 67 DAA | | | | | |
|---|---|---|---|---|---|---|---|
| Benzyl | Choline | CENJA | | | SOOS | | |
| g ae/ha | g ae/ha | Obs | Exp | [symbol] | Obs | Exp | [symbol] |
| 9.5 | 0 | — | — | — | 75 | — | — |
| 19 | 0 | 62 | — | — | — | — | — |
| 0 | 840 | 0 | — | — | 15 | — | — |
| 9.5 | 840 | — | — | — | 97 | 80 | 17 |
| 19 | 840 | 93 | 62 | 31 | — | — | — |

TABLE 10
Herbicidal effects (% visual injury) of Florpyrauxifen Benzyl
and 2,4-D Choline on pasture weeds-75 DAA

| | | Visual Weed Control (%)- | | |
|---|---|---|---|---|
| Florpyrauxifen | 2,4-D | 75 DAA | | |
| Benzyl | Choline | IVAAN | | |
| g ae/ha | g ae/ha | Obs | Exp | [symbol] |
| 9.5 | 0 | 25 | — | — |
| 12.5 | 0 | 48 | — | — |
| 0 | 840 | 30 | — | — |
| 9.5 | 840 | 78 | 48 | 30 |
| 12.5 | 840 | 96 | 63 | 33 |

TABLE 11
Herbicidal effects (% visual injury) of Florpyrauxifen Benzyl
and 2,4-D Choline on pasture weeds-80 DAA

| | | Visual Weed Control (%)- | | |
|---|---|---|---|---|
| Florpyrauxifen | 2,4-D | 80 DAA | | |
| Benzyl | Choline | HENAM | | |
| g ae/ha | g ae/ha | Obs | Exp | [symbol] |
| 12.5 | 0 | 40 | — | — |
| 0 | 840 | 90 | — | — |
| 12.5 | 840 | 100 | 94 | 6 |

TABLE 12
Herbicidal effects (% visual injury) of Florpyrauxifen Benzyl
and 2,4-D Choline on pasture weeds-83 DAA

| | | Visual Weed Control (%)- | | |
|---|---|---|---|---|
| Florpyrauxifen | 2,4-D | 83 DAA | | |
| Benzyl | Choline | IVAAN | | |
| g ae/ha | g ae/ha | Obs | Exp | [symbol] |
| 9.5 | 0 | 30 | — | — |
| 12.5 | 0 | 48 | — | — |
| 0 | 840 | 35 | — | — |
| 9.5 | 840 | 80 | 54 | 26 |
| 12.5 | 840 | 97 | 65 | 32 |

TABLE 13
Herbicidal effects (% visual injury) of Florpyrauxifen Benzyl and
2,4-D Choline on pasture weeds - 88 DAA

| Florpyrauxifen | 2,4-D | Visual Weed Control (%) - 88 DAA | | | | | |
|---|---|---|---|---|---|---|---|
| Benzyl | Choline | ASTPI | | | CENJA | | |
| g ae/ha | g ae/ha | Obs | Exp | [symbol] | Obs | Exp | [symbol] |
| 9.5 | 0 | 75 | — | — | — | — | — |
| 19 | 0 | — | — | — | 62 | — | — |
| 0 | 840 | 10 | — | — | 0 | — | — |
| 9.5 | 840 | 98 | 78 | 20 | — | — | — |
| 19 | 840 | — | — | — | 94 | 62 | 32 |

TABLE 14
Herbicidal effects (% visual injury) of Florpyrauxifen Benzyl and
2,4-D Choline on pasture weeds - 117 DAA

| Florpyrauxifen | 2,4-D | Visual Weed Control (%) - 117 DAA | | | | | |
|---|---|---|---|---|---|---|---|
| Benzyl | Choline | ASTPI | | | CENJA | | |
| g ae/ha | g ae/ha | Obs | Exp | [symbol] | Obs | Exp | [symbol] |
| 9.5 | 0 | 20 | — | — | 21 | — | — |
| 19 | 0 | — | — | — | 31 | — | — |
| 0 | 840 | 5 | — | — | 0 | — | — |
| 9.5 | 840 | 90 | 24 | 66 | 85 | 21 | 64 |
| 19 | 840 | — | — | — | 77 | 31 | 46 |

### Example 2

Field trials were established in multiple states in the United States to evaluate the safening effect of herbicide treatments to white clover (TRFRE, Trifolium repens) in existing pasture lands. Trials were designed as randomized complete blocks with four replicates. All trials were established with a minimum plot size of 3 meters (m) by 8 m (width×length).

Compositions comprising florpyrauxifen benzyl, 2,4-D choline, or combinations thereof were tested on the desirable vegetation white clover (TRFRE, Trifolium repens) to determine the herbicidal effect of the compositions on this desirable vegetation. All herbicide treatments were applied post-emergence with applications made to the white clover. Herbicides were applied with backpack sprayers using carbon dioxide (CO₂) as a propellant. The sprayers utilized flat fan spray nozzles calibrated to deliver a uniform spray pattern that provided thorough coverage of the foliage using a 187 L/ha spray volume. All treatments were applied with Activator 90 non-ionic surfactant at 0.25% v/v.

The white clover was evaluated on the number of days after application (DAA) given in each table below. Injury to the white clover was assessed visually at several intervals after application as percent overall injury, compared to an untreated control plot. The overall injury assessments were based on visual ratings of growth inhibition, leaf deformity, epinasty, and chlorosis. All treatment results, both for the single product and mixtures, are an average of four replicates.

The results are summarized in Tables 15-19 below. Abbreviations used in these tables are as follows:
DAA=days after application
g ae/ha=grams acid equivalent per hectare
Obs=observed value
Exp=expected value as calculated by Colby's equation
Δ=difference between observed value and expected value
TRFRE=Trifolium repens (white clover)

TABLE 15
Herbicidal effects (% visual injury) of Florpyrauxifen Benzyl
and 2,4-D Choline on white clover (TRFRE)-0 DAA

| Florpyrauxifen | 2,4-D | Visual Injury (%)-0 DAA | | |
|---|---|---|---|---|
| Benzyl | Choline | TRFRE | | |
| g ae/ha | g ae/ha | Obs | Exp | [symbol] |
| 9.44 | 0 | 30 | — | — |
| 0 | 754 | 30 | — | — |
| 9.44 | 754 | 30 | 51 | −21 |
| 9.5 | 0 | 7.5 | — | — |
| 12.5 | 0 | 6.5 | — | — |
| 19 | 0 | 6 | — | — |
| 0 | 840 | 6.5 | — | — |
| 9.5 | 840 | 6.5 | 13.5 | −7 |
| 12.5 | 840 | 4.8 | 12.6 | −7.8 |
| 19 | 840 | 5.8 | 12.1 | −6.3 |

TABLE 16
Herbicidal effects (% visual injury) of Florpyrauxifen Benzyl
and 2,4-D Choline on white clover (TRFRE)-7 DAA

| Florpyrauxifen | 2,4-D | Visual Injury (%)-7 DAA | | |
|---|---|---|---|---|
| Benzyl | Choline | TRFRE | | |
| g ae/ha | g ae/ha | Obs | Exp | [symbol] |
| 9.44 | 0 | 5 | — | — |
| 0 | 754 | 4.8 | — | — |
| 9.44 | 754 | 4.5 | 9.5 | −5 |
| 9.5 | 0 | 15 | — | — |
| 0 | 840 | 10 | — | — |
| 9.5 | 840 | 12.5 | 23.5 | −11 |

TABLE 17
Herbicidal effects (% visual injury) of Florpyrauxifen Benzyl
and 2,4-D Choline on white clover (TRFRE)-14 DAA

| | | Visual Injury (%)- | | |
|---|---|---|---|---|
| Florpyrauxifen | 2,4-D | 14 DAA | | |
| Benzyl | Choline | TRFRE | | |
| g ae/ha | g ae/ha | Obs | Exp | [symbol] |
| 9.44 | 0 | 91.2 | — | — |
| 0 | 754 | 86.2 | — | — |
| 9.44 | 754 | 85 | 98.9 | −13.9 |
| 9.5 | 0 | 22.5 | — | — |
| 12.5 | 0 | 22.5 | — | — |
| 19 | 0 | 17.5 | — | — |
| 0 | 840 | 15 | — | — |
| 9.5 | 840 | 17.5 | 34 | −16.5 |
| 12.5 | 840 | 15 | 34 | −19 |
| 19 | 840 | 15 | 30 | −15 |

TABLE 18
Herbicidal effects (% visual injury) of Florpyrauxifen Benzyl
and 2,4-D Choline on white clover (TRFRE)-21 DAA

| | | Visual Injury (%)- | | |
|---|---|---|---|---|
| Florpyrauxifen | 2,4-D | 21 DAA | | |
| Benzyl | Choline | TRFRE | | |
| g ae/ha | g ae/ha | Obs | Exp | [symbol] |
| 9.5 | 0 | 10 | — | — |
| 12.5 | 0 | 10 | — | — |
| 19 | 0 | 7.5 | — | — |
| 0 | 840 | 11.2 | — | — |
| 9.5 | 840 | 8.8 | 20.1 | −11.3 |
| 12.5 | 840 | 8.8 | 20.2 | −11.4 |
| 19 | 840 | 7.5 | 17.9 | −10.4 |

TABLE 19
Herbicidal effects (% visual injury) of Florpyrauxifen Benzyl
and 2,4-D Choline on white clover (TRFRE)-28 DAA

| | | Visual Injury (%)- | | |
|---|---|---|---|---|
| Florpyrauxifen | 2,4-D | 28 DAA | | |
| Benzyl | Choline | TRFRE | | |
| g ae/ha | g ae/ha | Obs | Exp | [symbol] |
| 9.5 | 0 | 11.2 | — | — |
| 12.5 | 0 | 7.5 | — | — |
| 0 | 840 | 10 | — | — |
| 9.5 | 840 | 2.5 | 20.2 | −17.7 |
| 12.5 | 840 | 6.2 | 17 | −10.8 |

### Example 3

Field trials were established in Germany and Ireland to evaluate the safening effect of herbicide treatments to white clover (TRFRE, Trifolium repens) in existing pasture lands. Trials were designed as randomized complete blocks with four replicates. All trials were established with a minimum plot size of 3 meters (m) by 8 m (width×length).

Compositions comprising florpyrauxifen benzyl, amidosulfuron, or combinations thereof were tested on the desirable vegetation white clover (TRFRE, Trifolium repens) to determine the herbicidal effect of the compositions on this desirable vegetation. All herbicide treatments were applied post-emergence with applications made to the white clover. Herbicides were applied with backpack sprayers using carbon dioxide (CO₂) as a propellant. The sprayers utilized flat fan spray nozzles calibrated to deliver a uniform spray pattern that provided thorough coverage of the foliage using a 200 L/ha spray volume. All treatments were applied with Actirob B adjuvant at 0.25% v/v.

The white clover was evaluated on the number of days after application (DAA) given in each table below. Injury to the white clover was assessed visually at several intervals after application as percent overall injury, compared to an untreated control plot. The overall injury assessments were based on visual ratings of growth inhibition, leaf deformity, epinasty, and chlorosis. All treatment results, both for the single product and mixtures, are an average of four replicates.

The results are summarized in Tables 20-21 below. Abbreviations used in these tables are as follows:
DAA=days after application
g ae/ha=grams acid equivalent per hectare
Obs=observed value
Exp=expected value as calculated by Colby's equation
Δ=difference between observed value and expected value
TRFRE=Trifolium repens (white clover)

TABLE 20
Injury (% visual injury) of Florpyrauxifen Benzyl and
Amidosulfuron on white clover (TRFRE)-Germany trials

| | Florpyrauxifen | | Visual Injury (%) | | |
|---|---|---|---|---|---|
| | Benzyl | Amidosulfuron | TRFRE | | |
| DAA | g ae/ha | g ae/ha | Obs | Exp | [symbol] |
| 0 | 9.44 | 0 | 70 | — | — |
| 0 | 0 | 45 | 70 | — | — |
| 0 | 9.44 | 45 | 70 | 91 | −21 |
| 14 | 9.44 | 0 | 32 | — | — |
| 14 | 0 | 45 | 16 | — | — |
| 14 | 9.44 | 45 | 30 | 44 | −14 |

TABLE 21
Injury (% visual injury) of Florpyrauxifen Benzyl and
Amidosulfuron on white clover (TRFRE)-Ireland trials

| | Florpyrauxifen | | Visual Injury (%) | | |
|---|---|---|---|---|---|
| | Benzyl | Amidosulfuron | TRFRE | | |
| DAA | g ae/ha | g ae/ha | Obs | Exp | [symbol] |
| 0 | 9.44 | 0 | 30 | — | — |
| 0 | 0 | 45 | 30 | — | — |
| 0 | 9.44 | 45 | 29 | 51 | −22 |
| 7 | 9.44 | 0 | 71 | — | — |
| 7 | 0 | 45 | 68 | — | — |
| 7 | 9.44 | 45 | 69 | 90 | −21 |
| 14 | 9.44 | 0 | 91 | — | — |
| 14 | 0 | 45 | 71 | — | — |
| 14 | 9.44 | 45 | 85 | 97 | −12 |
| 28 | 9.44 | 0 | 16 | — | — |
| 28 | 0 | 45 | 14 | — | — |
| 28 | 9.44 | 45 | 12 | 27 | −15 |
| 163 | 9.44 | 0 | 71 | — | — |
| 163 | 0 | 45 | 80 | — | — |
| 163 | 9.44 | 45 | 79 | 94 | −15 |
| 163 | 9.44 | 0 | 12 | — | — |
| 163 | 0 | 45 | 14 | — | — |
| 163 | 9.44 | 45 | 13 | 24 | −11 |
| 310 | 9.44 | 0 | 79 | — | — |
| 310 | 0 | 45 | 88 | — | — |
| 310 | 9.44 | 45 | 86 | 97 | −11 |
| 310 | 9.44 | 0 | 4 | — | — |
| 310 | 0 | 45 | 4 | — | — |
| 310 | 9.44 | 45 | 4 | 8 | −4 |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various aspects, the terms “consisting essentially of” and “consisting of” can be used in place of “comprising” and “including” to provide for more specific aspects of the invention and are also disclosed. Other than in the examples, or where otherwise noted, all numbers expressing quantities of ingredients, reaction conditions, and so forth used in the specification and claims are to be understood to be construed in light of the number of significant digits and ordinary rounding approaches, and not as an attempt to limit the application of the doctrine of equivalents to the scope of the claims.

1. A composition comprising 4-amino-3-chloro-6-(4-chloro-2-fluoro-3-methoxyphenyl)-5-fluoro-pyridine-2-carboxylic acid (florpyrauxifen), an agriculturally acceptable salt or ester thereof, or a combination thereof, and a second herbicide comprising 2,4-D, an agriculturally acceptable salt or ester thereof, or a combination thereof, wherein the composition is safened for use on white clover (Trifolium repens, TRFRE).

2. The composition of claim 1, wherein the weight ratio of the florpyrauxifen (in g ae/ha) to the second herbicide (in g ae/ha) is from about 1:1500 to about 1:8.

3. The composition of claim 1, wherein the florpyrauxifen is florpyrauxifen-benzyl.

4. The composition of claim 1, wherein the second herbicide is selected from the group consisting of 2,4-D, 2,4-D choline, 2,4-D dimethylammonium, and combinations thereof.

5. The composition of claim 1, further comprising a third herbicide selected from the group consisting of amidosulfuron, saflufenacil, agriculturally acceptable salts or esters thereof, and combinations thereof.

6. A composition comprising 4-amino-3-chloro-6-(4-chloro-2-fluoro-3-methoxyphenyl)-5-fluoro-pyridine-2-carboxylic acid (florpyrauxifen), an agriculturally acceptable salt or ester thereof, or a combination thereof, and a second herbicide comprising amidosulfuron, an agriculturally acceptable salt or ester thereof, or a combination thereof, wherein the composition is safened for use on white clover (Trifolium repens, TRFRE).

7. The composition of claim 6, wherein the weight ratio of the florpyrauxifen (in g ae/ha) to the second herbicide (in g ae/ha) is from about 1:60 to about 3:1.

8. The composition of claim 6, wherein the florpyrauxifen is florpyrauxifen-benzyl.

9. The composition of claim 6, further comprising a third herbicide selected from the group consisting of 2,4-D, saflufenacil, agriculturally acceptable salts or esters thereof, and combinations thereof.

10. A composition comprising 4-amino-3-chloro-6-(4-chloro-2-fluoro-3-methoxyphenyl)-5-fluoro-pyridine-2-carboxylic acid (florpyrauxifen), an agriculturally acceptable salt or ester thereof, or a combination thereof, and a second herbicide comprising saflufenacil, an agriculturally acceptable salt or ester thereof, or a combination thereof, wherein the composition is safened for use on white clover (Trifolium repens, TRFRE).

11. The composition of claim 10, wherein the weight ratio of the florpyrauxifen (in g ae/ha) to the second herbicide (in g ae/ha) is from about 1:80 to about 60:1.

12. The composition of claim 10, wherein the florpyrauxifen is florpyrauxifen-benzyl.

13. The composition of claim 10, further comprising a third herbicide selected from the group consisting of 2,4-D, amidosulfuron, agriculturally acceptable salts or esters thereof, and combinations thereof.

14. A method of controlling undesirable vegetation, comprising applying to vegetation or an area adjacent to the vegetation or applying to soil or water to limit the emergence or growth of vegetation, the composition of claim 1, wherein the composition is safened for use on white clover (Trifolium repens, TRFRE).

15. The method of claim 14, wherein wherein the weight ratio of the florpyrauxifen (in g ae/ha) to the 2,4-D (in g ae/ha) is from about 1:1500 to about 1:8.

16. A method of controlling undesirable vegetation, comprising applying to vegetation or an area adjacent to the vegetation or applying to soil or water to limit the emergence or growth of vegetation, the composition of claim 6, wherein the weight ratio of the florpyrauxifen (in g ae/ha) to the amidosulfuron (in g ae/ha) is from about 1:60 to about 3:1.

17. A method of controlling undesirable vegetation, comprising applying to vegetation or an area adjacent to the vegetation or applying to soil or water to limit the emergence or growth of vegetation, the composition of claim 10, wherein the weight ratio of the florpyrauxifen (in g ae/ha) to the saflufenacil (in g ae/ha) is from about 1:80 to about 60:1.

18. The method of claim 14, wherein the florpyrauxifen is florpyrauxifen-benzyl.

19. The method of claim 14, wherein the composition further comprising a third herbicide selected from the group consisting of amidosulfuron, saflufenacil, an agriculturally acceptable salt or ester thereof, and combinations thereof.

20. The method of claim 14, wherein the florpyrauxifen and the second herbicide are applied simultaneously.
